(19) United States
(12) Patent Application Publication
(10) Pub. No.: US 2013/0071685 A1
(43) Pub. Date: Mar. 21, 2013

(54) PRODUCT AND METHOD FOR MANUFACTURING THE PRODUCT

(71) Applicants: Daisuke IWAKI, Katsushika-ku (JP); Hiroshi IWAKI, Katsushika-ku (JP)

(72) Inventors: Daisuke IWAKI, Katsushika-ku (JP); Hiroshi IWAKI, Katsushika-ku (JP)

(73) Assignee: IWAKI FILM PROCESSING CO., LTD., Katsushika-ku (JP)

(21) Appl. No.: 13/238,111

(22) Filed: Sep. 21, 2011

(51) Int. Cl. B32B 15/04; B05D 3/12; B05D 3/02; B05D 7/14; B32B 3/02; B05D 1/36

(52) U.S. Cl. 428/621; 428/80; 427/383.7; 264/129

(57) ABSTRACT

A product includes a product body, a metallic plating layer and a resin layer. The product body is a rod-like member mainly including a metallic material. The metallic plating layer has a metallic luster on its surface and covers an exterior surface of the product body. The resin layer includes a thermosetting resin and an adhesive component and is adhered to the surface of the metallic plating layer, permitting the metallic plating layer to be seen through the resin layer.

### BACKGROUND OF THE INVENTION

1. Field of the Invention

The present invention relates to a product and a method for manufacturing the product.

2. Description of the Related Art

Recently, sporting goods such as golf goods, ski goods and hiking goods have reached the limits of structural improvement and new material development for functional advancement. Regarding sporting goods of this type, accordingly, variety of design and improvement in decorativeness of products are becoming more important so as to increase the market value of products and stimulate consumer appetite. As a technology for improving such decorativeness, there has been known Japanese Unexamined Patent Application Publication No. 2003-284795.

Japanese Unexamined Patent Application Publication No. 2003-284795 discloses an invention in which a metallic ornament layer is formed on the surface of a golf club shaft comprising a fiber-reinforced resin by using a physical vapor deposition process such as vacuum evaporation, sputtering or ion plating, a chemical vapor deposition process such as plasma CVD, a wet plating process or a metallic film formation process with a double gun spray using silver mirror reaction, and a protection layer is further provided outside the formed metallic ornament layer so as to prevent scratch or peeling.

However, if such a protection layer comprises a synthetic resin coating, there is a problem that the synthetic resin coating becomes less adhesive as the surface of the metallic ornament layer becomes less rugged. For example, since the surface of the metallic ornament layer disclosed in Japanese Unexamined Patent Application Publication No. 2003-284795 has fine irregularities resulting from the foregoing metallic film formation processes, it is not necessarily impossible to adhere the synthetic resin coating.

In the case where a metallic plating layer is formed on the surface of a golf club steel shaft by electroplating or chemical reduction plating, however, the metallic plating layer has a mirror-like smooth surface, making it impossible to adhere the synthetic resin coating.

In the prior art, accordingly, when a synthetic resin coating is used for forming a resin layer on the metallic plating layer formed on the surface of the golf club steel shaft, the surface of the metallic plating layer is subjected to a sandblasting treatment before the coating process to have fine irregularities or the metallic plating layer is completely removed. In such a coating process, the number of processing steps increases by the sandblasting treatment, resulting in a cost increase.

On such a golf club steel shaft, moreover, there is formed a metallic plating layer mainly comprising chromium (Cr). Since chromium has a bright metallic luster, if the metallic luster can be used as a decorative element for products, decorativeness of the products can be improved. In the conventional coating process, however, since the metallic plating layer loses its metallic luster when subjected to a sandblasting treatment, the metallic luster cannot be incorporated into design.

### SUMMARY OF THE INVENTION

It is an object of the present invention to provide a product in which a metallic plating layer is protected but a metallic luster on the surface of the metallic plating layer can be used as a decorative element and a method for manufacturing the product.

It is another object of the present invention to provide a product which can be variously decorated at a low cost and a method for manufacturing the product.

In order to achieve the above object, a product according to the present invention comprises a product body, a metallic plating layer and a resin layer. The product body is a rod-like member mainly comprising a metallic material. The metallic plating layer has a metallic luster on its surface and covers an exterior surface of the product body. The resin layer comprises a thermosetting resin and an adhesive component and is adhered to the surface of the metallic plating layer, permitting the metallic plating layer to be seen through the resin layer.

The above structure permits baking finishing because the resin layer contains a thermosetting resin and the product body mainly comprises a metallic material. Accordingly, coating can be performed with an existing equipment at a low cost without the need of using a special equipment.

The metallic plating layer has a metallic luster on its surface and covers an exterior surface of the product body. Since such a metallic plating layer has a mirror-like smooth surface, it has been impossible to adhere a resin coating to it. However, the resin layer according to the present invention ensures adhesion to the metallic plating layer because of having an adhesive component, so that the resin layer can be adhered to the surface of the metallic plating layer. Accordingly, the surface of the metallic plating layer can be protected from an external physical impact.

The resin layer is adhered to the surface of the metallic plating layer, permitting the metallic plating layer to be seen through the resin layer. With this structure, the metallic luster on the surface of the metallic plating layer can be used as a decorative element.

If the resin layer further comprises a coloring component, the metallic luster on the surface of the metallic plating layer emerges as a metallic color affected by a color of the coloring component, thereby improving decorativeness.

A method for manufacturing the product according to the present invention comprises the steps of:

forming the metallic plating layer on the surface of the product body by electroplating or chemical reduction plating;

applying a coating comprising a thermosetting resin and an adhesive component to the surface of the metallic plating layer; and

hardening the coating by subjecting the product body to a heat treatment.

In the above manufacturing method, since the coating contains an adhesive component, the resin layer can be formed by directly applying the coating to the surface of the metallic plating layer without previously subjecting the metallic plating layer to a sandblasting treatment. Accordingly, the metallic luster on the surface of the metallic plating layer can be used as a decorative element to improve appearance of the product.

In the present invention having at least one resin layer formed on the surface of the metallic plating layer, furthermore, the resin layer may be used as a base for ensuring adhesion of another resin layer containing a coloring component. With this structure, the metallic plating layer can be protected more reliably from an external physical impact and decorativeness can also be improved.

A product according to another aspect of the present invention comprises a product body and a resin layer. The product body is a rodlike member mainly comprising a metallic material or a fiber-reinforced plastic. The resin layer comprises a resin component and a coloring component and has an opening leading to a surface of the product body within an area where the resin layer is adhered to the surface of the product body.

Effects of the above product can be understood more clearly by considering its manufacturing method. More specifically, the method for manufacturing the product according to another aspect of the present invention comprises the steps of:

printing a peelable coating on the surface of the product body by screen printing to form a peelable area on the surface of the product body in accordance with a mask pattern;

applying a resin coating comprising a resin component and a coloring component to the surface of the metallic plating layer and a surface of the peelable area; and

removing the peelable area and the resin coating applied onto the peelable area.

According to the product according to another aspect of the present invention and its manufacturing method, various decorations such as hollow letters or hollow patterns can be made on the surface of the product body in accordance with a mask pattern. As a result, for example, the contrast between the coloring component of the resin layer and a base color appearing at the opening can be used as a decorative element. Moreover, since decorations can be made by a screen printing technique, the manufacturing cost can be reduced.

As has been described above, the following effects can be obtained according to the present invention.
(a) To provide a product in which a metallic plating layer is protected but a metallic luster on the surface of the metallic plating layer can be used as a decorative element and a method for manufacturing the product.
(b) To provide a product which can be variously decorated at a low cost and a method for manufacturing the product.

The present invention will be more fully understood from the detailed description given hereinbelow and the accompanying drawings which are given by way of illustration only, and thus not to be considered as limiting the present invention.

### BRIEF DESCRIPTION OF THE DRAWINGS

FIG. 1 is a sectional view of a product according to one embodiment of the present invention;

FIG. 2 is a drawing showing a part of the sectional view shown in FIG. 1 on an enlarged scale;

FIG. 3 is a sectional view showing a method for manufacturing a product according to one embodiment of the present invention with its ends omitted;

FIG. 4 is a sectional view showing a process after the process shown in FIG. 3;

FIG. 5 is a sectional view showing a process after the process shown in FIG. 4;

FIG. 6 is a sectional view of a product according to another embodiment of the present invention;

FIG. 7 is a sectional view of a product according to still another embodiment of the present invention;

FIG. 8 is a sectional view of a product according to still another embodiment of the present invention;

FIG. 9 is a front view showing a method for manufacturing a product according to still another embodiment of the present invention with its ends omitted;

FIG. 10 is a front view showing a process after the process shown in FIG. 9;

FIG. 11 is a sectional view taken along line 11-11 in FIG. 10;

FIG. 12 is a front view showing a process after the process shown in FIGS. 10 and 11;

FIG. 13 is a sectional view taken along line 13-13 in FIG. 12;

FIG. 14 is a sectional view showing a product according to still another embodiment of the present invention with its ends omitted;

FIG. 15 is a front view showing a method for manufacturing a product according to still another embodiment of the present invention with its ends omitted;

FIG. 16 is a front view showing a process after the process shown in FIG. 15;

FIG. 17 is a sectional view taken along line 17-17 in FIG. 16;

FIG. 18 is a front view showing a process after the process shown in FIGS. 16 and 17; and

FIG. 19 is a sectional view taken along line 19-19 in FIG. 18.

### DESCRIPTION OF THE PREFERRED EMBODIMENTS

The product according to the present invention is a golf club shaft, a fishing rod, a walking stick, a ski pole, a trekking pole, a tennis racket or a badminton racket. In the following description, a golf club shaft is taken as an example for convenience of explanation, but it should not be construed as limitative.

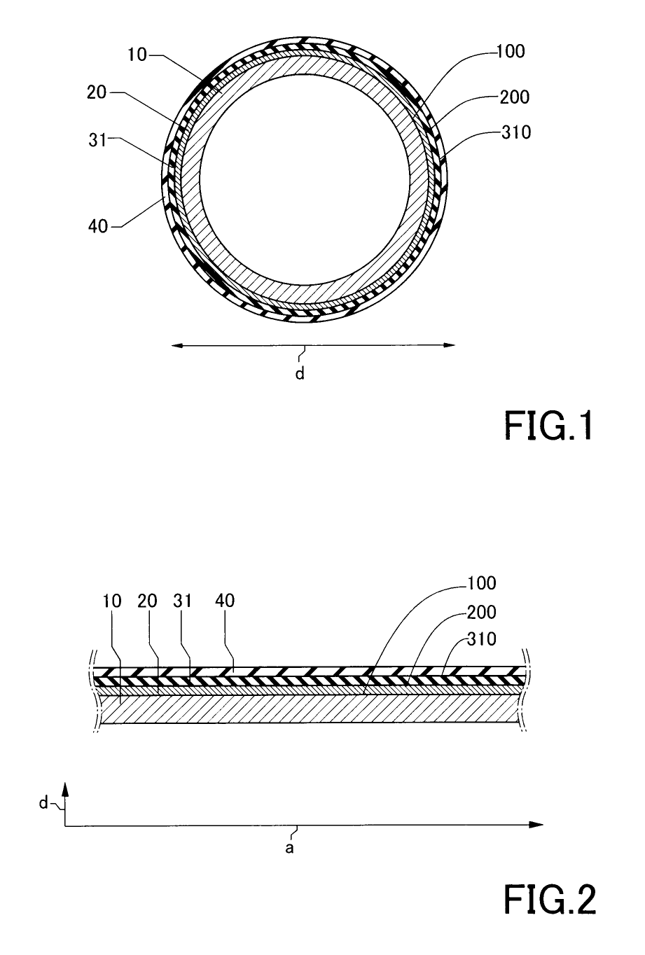

FIGS. 1 and 2 illustrate a product comprising a product body 10, a metallic plating layer 20, a resin layer 31 and a protection layer 40. The product body 10 is a rod-like member mainly comprising a metallic material. As used herein, the term “rod-like member” only means that a length taken along an axial direction “a” is larger than a maximum diameter taken along a radial direction “d”.

In the case where the product body 10 is a so-called steel shaft, the metallic material is a steel, more preferably, a carbon steel (an alloy of Fe and C) or a special steel obtained by adding chromium (Cr), molybdenum (Mo), nickel (Ni), vanadium (V), etc.

Moreover, the product body 10 has a structure typical of steel shafts. That is, the product body 10 is a tube-like or pipe-like member having a circular section and tapered along the axial direction “a” from one end (grip side) to the other end (head side) with a through hole passing through it along the axial direction “a”.

The metallic plating layer 20 is provided to cover an exterior surface 100 of the product body 10 from the viewpoint of imparting impact resistance, abrasion resistance, corrosion resistance, weather resistance and decorativeness to the product body 10. Usually, the metallic plating layer 20 to be applied to the steel shaft is formed by electroplating or chemical reduction plating. The metallic plating layer 20 should have a thickness that will never impair various properties required for steel shafts such as flex, torsional rigidity and kick point and is preferably formed on the exterior surface 100 with a thickness of about 0.1 μm.

The metallic plating layer 20 has a surface 200 which is a mirror-like smooth surface having a metallic luster and a mirror gloss. In the case where the metallic plating layer 20 mainly comprises chromium (Cr), particularly, the surface 200 has a white metallic luster of chromium (Cr).

In FIGS. 1 and 2, the metallic plating layer 20 is depicted as having a single-layer structure for convenience of explanation, but it should not be construed as limitative. For example, the metallic plating layer 20 may have a multilayer structure of a nickel plating layer and a chromium plating layer, wherein the nickel plating layer is formed on the exterior surface 100 of the product body 10 with a thickness of about 5 to 15 μm, and the chromium plating layer is further formed on the surface of the nickel plating layer with a thickness of about 0.1 μm. The above multilayer structure of the plating layer is called “decorative chromium plating.”

One characteristic feature of the present invention resides in that the resin layer 31 is adhered to the surface 200 of the metallic plating layer 20. The resin layer 31 of FIGS. 1 and 2 contains not only a thermosetting resin as a main component but also an adhesive component and a coloring component and is adhered to the surface 200 of the metallic plating layer 20. The resin layer 31 is a baked film having a layer thickness of, preferably, 0.3 mm or less, more preferably, 0.1 mm or less.

The adhesive component of the resin layer 31 contains, as a main component, at least one kind of material selected from the group consisting of an isocyanate, a block isocyanate resin and a silane coupling agent. The silane coupling agent includes an epoxy group and a silane (Si) in its structure and is preferably selected from the following (i) to (v).
(i) 3-Aminopropyltriethoxysilane
(ii)3-Aminopropyltrimethoxysilane
(iii) N-(2-Aminoethyl)-3-Aminopropyltrimethoxysilane
(iv) N-(2-Aminoethyl)-3-Aminopropylmethyldimethoxysilane
(v) 3-(N-Phenyl)-3-Aminopropyltrimethoxysilane

In the present invention, the term “adhesion” refers to the property of being inseparable during the service life of the product. In the present invention, the term “adhesive component” refers to a material which has an adhesive effect by itself and does not include an auxiliary adhesive material such as adhesion promoter.

The thermosetting resin of the resin layer 31 is capable of being mixed with an adhesive component and can be selected from baking finish resins generally used for baking finishing. In the present invention, the term “baking finishing” refers to a coating process in which a binder is crosslinked and hardened by heating a layer of an applied coating at a preset minimum temperature. On the other hand, the term “baking finish” refers to a coating which can form a film by heating after application to a substrate, wherein the heating temperature is 100° C. or more.

The thermosetting resin of the resin layer 31 comprises at least one kind of material selected from the group consisting of a melamine resin (MF), a phenolic resin (PF), an epoxy resin (EP), a urea resin (UF), an unsaturated polyester resin (UP) and a diallyl phthalate resin (PDAP or DAP).

The resin layer 31 permits the metallic plating layer 20 to be seen through a surface 310 of the resin layer 31. That is, the resin layer 31 is transparent. Transparency (transmittance) of the resin layer 31 can be obtained by properly selecting resin components. When an epoxy resin (EP) is used as the thermosetting resin, for example, the resin layer 31 becomes transparent to such a degree that the metallic plating layer 20 can be seen through the surface 310. The resin layer 31 also becomes transparent by containing, as a resin component, not only the thermosetting resin but also at least one of an acrylic resin and an urethane resin.

The coloring component mainly comprises a dye or a pigment and is mixed at a ratio of 15 wt. % or less. The coloring component can be selected from conventionally used ones without particular limitation. Examples of the coloring component include a titanium oxide, an organic red pigment, a barium sulfate and a carbon black. The content of the coloring component can be adjusted depending on a color tone.

In the product of FIGS. 1 and 2, the protection layer 40 is adhered to the surface 310 of the resin layer 31 with a transparent synthetic resin material. The resin of the protection layer 40 can be selected from ones having recoatability with the resin layer 31 or ones capable of being adhered to the resin layer 31 and is preferably the same as or similar to the synthetic resin material of the resin layer 31. The protection layer 40 is provided to ensure impact resistance, abrasion resistance, corrosion resistance, weather resistance, etc. (durability) and may have a higher hardness than the resin layer 31.

In FIGS. 1 and 2, the protection layer 40 is depicted as having a single-layer structure, but it should not be construed as limitative. The durability can be improved by adhering a plurality of transparent protection layers 40 to the resin layer 31.

The structure of the product of FIGS. 1 and 2 enables baking finishing because the resin layer 31 mainly comprises a thermosetting resin and the product body 10 mainly comprises a metallic material. The baking finishing can be performed with an existing coating equipment at a low cost without the need of using a special or expensive equipment.

The metallic plating layer 20 has a metallic luster on its surface 200 and covers the exterior surface 100 of the product body 10. In the case where the metallic plating layer 20 is formed by electroplating or chemical reduction plating, the surface 200 becomes a mirror-like smooth surface, so that it has been impossible to adhere a resin layer 31 formed by using a resin coating. However, the resin layer 31 according to one embodiment of the present invention ensures adhesion to the metallic plating layer 20 because of having an adhesive component mainly comprising a silane coupling agent, so that the resin layer 31 can be adhered to the surface 200 even though it is a mirror-like surface. Accordingly, the surface 200 of the metallic plating layer 20 can be protected from an external physical impact to ensure durability.

The resin layer 31 of FIGS. 1 and 2 contains not only a transparent thermosetting resin as a main component but also a coloring component and is adhered to the surface 200 of the metallic plating layer 20, permitting the metallic plating layer 20 to be seen through the surface 310. With this structure, since the metallic luster on the surface 200 emerges as a metallic color affected by a color of the coloring component, the metallic luster on the surface 200 can be used as a decorative element to improve appearance of the product.

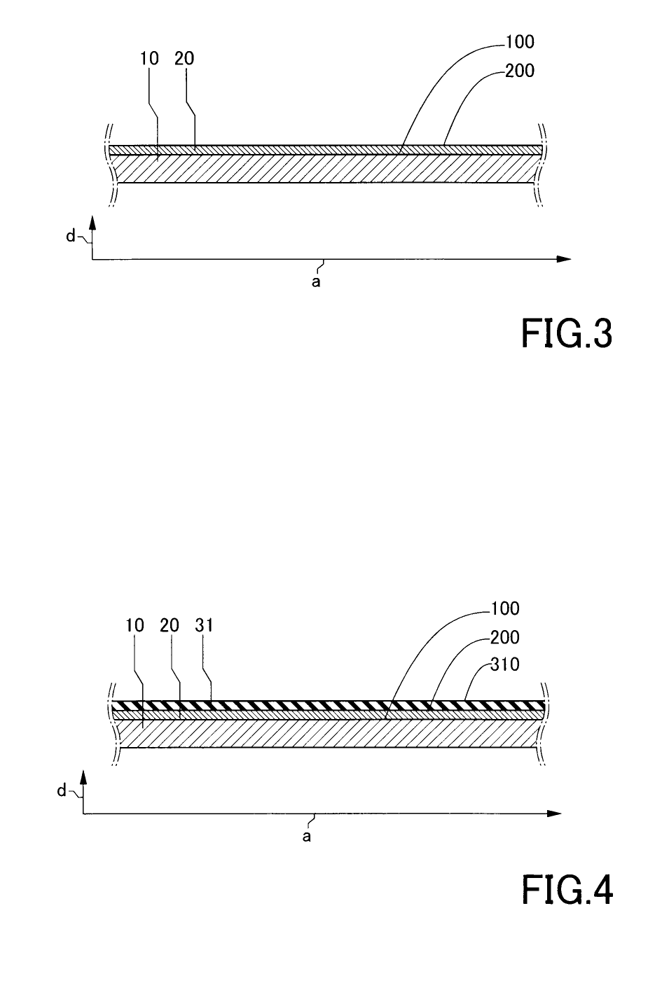

The effects of the product shown in FIGS. 1 and 2 will be further described from the viewpoint of the manufacturing method. Referring first to FIG. 3, the metallic plating layer 20 is formed on the exterior surface 100 of the product body 10 by electroplating or chemical reduction plating. Prior to applying a coating thereto, the metallic plating layer 20 is subjected to a cleaning treatment. Specifically, the cleaning treatment includes a washing process and a degreasing process, and in the washing process, dust or stain adhering to the surface 200 of the metallic plating layer 20 is removed by using a neutral detergent. In the degreasing process, greasy stain adhering to the surface 200 of the metallic plating layer 20 after the washing process is removed by a waste impregnated with naphtha.

FIG. 4 shows a process after the process shown in FIG. 3, wherein a coating (baking finish) containing not only a thermosetting resin as a main component but also an adhesive component and a coloring component is applied to the surface 200 of the metallic plating layer 20 to form a coating layer which becomes the resin layer 31. The coating used in the process of FIG. 4 may further contain a diluent. In the present invention, the diluent is used for adjusting the viscosity of a coating and can be selected from conventionally used ones. Preferably, the diluent is an organic solvent and particularly comprises at least one kind of material selected from the group consisting of toluene, xylene, isopropyl alcohol, n-butyl alcohol, isobutyl alcohol, ethyl acetate and butyl acetate.

In the case where the product according to the present invention is a golf shaft, the coating process of FIG. 4 can be performed by spray coating with a spray gun or dip and squeeze coating. In the dip and squeeze coating, at first, a baking finish is put in a cup. At its bottom, the cup has a rubber plate having a thickness of about 0.8 to 2.0 mm, wherein a circular through hole having a diameter of about 4.0 to 5.5 mm has an opening in the surface of the rubber plate. The product body 10 is inserted into the through hole from the tip on the smaller-diameter side (head side), dipped into the baking finish in the cup, and then pulled out from the through hole, thereby forming a coating layer on the surface 200 of the metallic plating layer 20.

Then, the work in process having the coating layer formed on the metallic plating layer 20 is subjected to a heat treatment to harden the coating layer. The heat treatment is performed such that the work in process is led into an electric furnace having a closed heat treatment chamber and heated as a whole in an atmosphere within a predetermined temperature range. The temperature range is preferably from 100 to 200° C., and more preferably from 150 to 180° C. On the other hand, the processing time is preferably from 10 to 30 minutes. When subjected to a heat treatment in an atmosphere having a temperature of 150° C., for example, the coating layer can be hardened in about 15 minutes, thereby forming the resin layer 31.

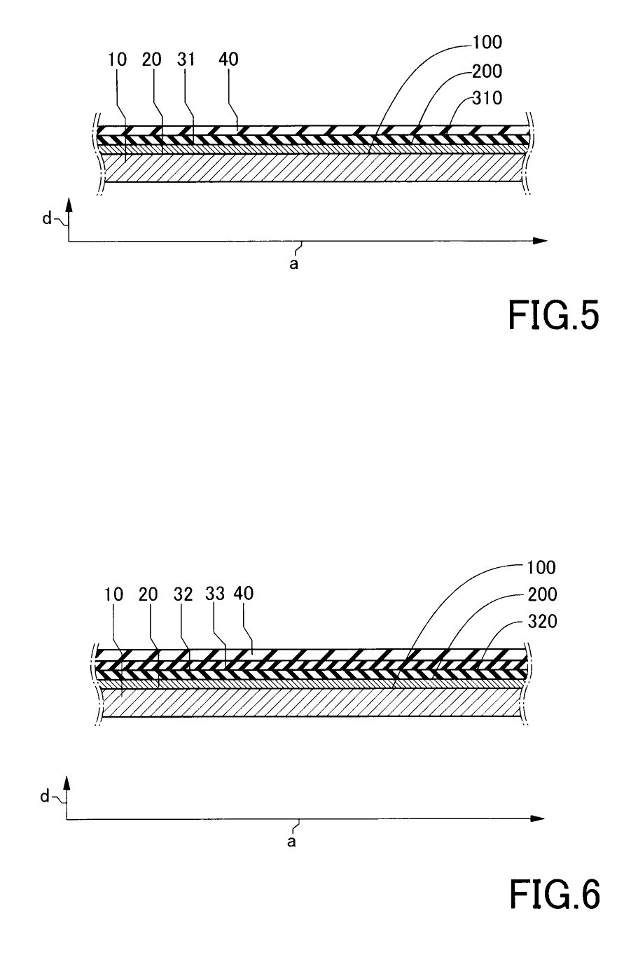

FIG. 5 shows a process after the process shown in FIG. 4, wherein the protection layer 40 is further formed on the surface 310 of the resin layer 31. The protection layer 40 can be formed such that a transparent synthetic resin material having recoatability with the resin layer 31 is applied to the surface 310 by dip and squeeze coating and then subjected to a heat treatment under the above-mentioned conditions. The protection layer 40 may have a multilayer structure by repeating the coating process and the heat treatment process a given number of times depending on durability required for the product.

In the product manufacturing method described with reference to FIGS. 3 to 5, since the coating used for forming the resin layer 31 contains not only a thermosetting resin as a main component but also an adhesive component, it can be directly applied to the surface 200 without previously subjecting the surface 200 of the metallic plating layer 20 to a sandblasting treatment. Accordingly, the metallic luster on the surface 200 of the metallic plating layer 20 can be used as a decorative element to improve appearance of the product.

Heretofore, since a deposited metal film formed by a metallic film formation process using vacuum evaporation or the like is liable to peel, it has been required that the resin layer (31) should be formed immediately after the formation of the deposited metal film. On the other hand, the resin layer 31 according to the present invention is easy to form because it can be adhered to the surface 200 of the metallic plating layer 20. Moreover, if there is something wrong with the formed coating film, the coating process can be repeated to improve production yield.

Since the coating used for forming the resin layer 31 contains not only a transparent thermosetting resin as a main component but also a coloring component, the metallic luster on the surface 200 of the metallic plating layer 20 emerges as a metallic color affected by a color of the coloring component. Thus, decorativeness of the product can be improved.

With the resin layer 31 formed on the surface 200 of the metallic plating layer 20, the resin layer 31 can serve as a base, and the protection layer 40 can be further formed on the surface 310 by using a transparent resin coating having recoatability with the resin layer 31. This prevents peeling or improper movement of the resin layer 31 and also ensures durability.

In an embodiment of FIG. 6, two effects achieved by the single-layer resin layer 31 of FIGS. 1 to 5, i.e., the effect of adhering to the surface 200 of the metallic plating layer 20 and the decorative effect of permitting emergence of the metallic luster are achieved by a multilayer structure. Hereinbelow, description will be made mainly about differences.

In the embodiment of FIG. 6, the product comprises the product body 10, the metallic plating layer 20, a first resin layer 32, a second resin layer 33 and the protection layer 40.

The first resin layer 32 comprises a transparent thermosetting resin and an adhesive component and is adhered to the surface 200 of the metallic plating layer 20. The thermosetting resin and the adhesive component of the first resin layer 32 can be the same as those of the resin layer 31 described with reference to FIGS. 1 to 5.

The second resin layer 33 comprises a transparent thermosetting resin and a coloring component and is adhered to a surface 320 of the first resin layer 32, permitting the metallic plating layer 20 to be seen through its surface.

The thermosetting resin and the coloring component of the second resin layer 33 can be the same as those described with reference to FIGS. 1 to 5. Moreover, the resin of the second resin layer 33 can be selected from ones having recoatability with the first resin layer 32 or ones capable of being adhered to the first resin layer 32 and is preferably the same as or similar to the thermosetting resin of the first resin layer 32.

All the advantages described with reference to FIGS. 1 to 5 can also be obtained according to the embodiment of FIG. 6. In the embodiment of FIG. 6, moreover, the first resin layer 32 serves as a base for the second resin layer 33. With this structure, even if the surface 100 of the product body 10 or the surface 200 of the metallic plating layer 20 has a surface defect such as scratch or irregularities, the surface defect can be eliminated by the first resin layer 32 and after the elimination, the second resin layer 33 can be adhered to the surface 320 of the first resin layer 32. This improves not only production yield but also decorativeness.

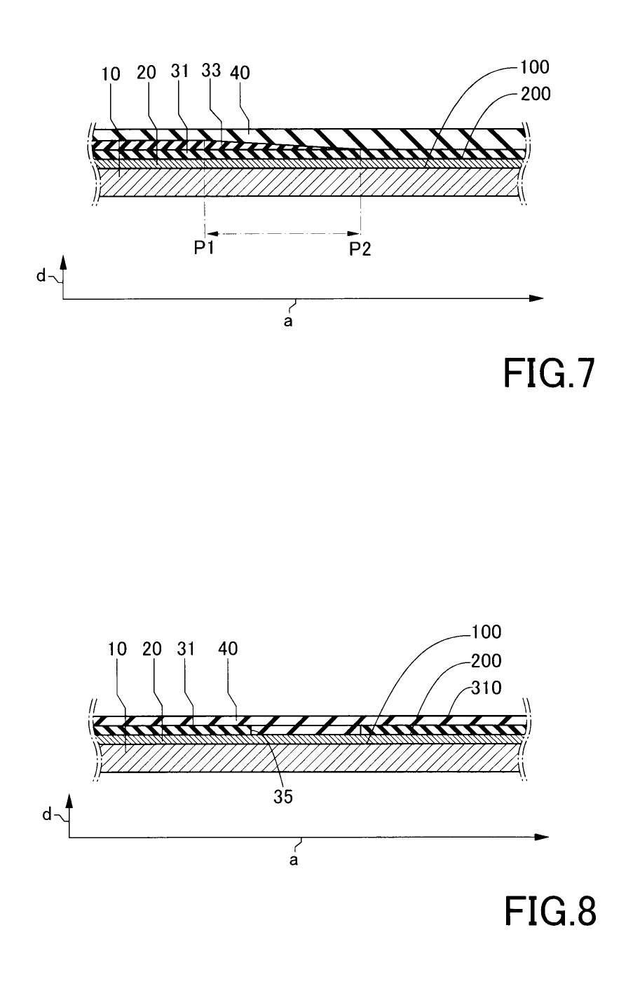

FIG. 7 shows an embodiment which differs from the embodiment of FIGS. 1 to 5 in having a second resin layer 33. Hereinbelow, description will be made mainly about differences from the embodiment of FIGS. 1 to 5.

In the product of FIG. 7, the resin layer 31 comprises a transparent thermosetting resin, an adhesive component and a coloring component and is adhered to the surface 200 of the metallic plating layer 20, preferably permitting the metallic plating layer 20 to be seen through the surface 310. The second resin layer 33 comprises a transparent thermosetting resin and a coloring component and is adhered to the surface 310 of the resin layer 31, permitting the surface 200 of the metallic plating layer 20 or the surface 310 of the resin layer 31 to be seen through its surface.

The thermosetting resin and the coloring component of the second resin layer 33 can be the same as those described with reference to FIG. 6. Moreover, the resin of the second resin layer 33 can be selected from ones having recoatability with the resin layer 31 or ones capable of being adhered to the resin layer 31 and is preferably the same as or similar to the thermosetting resin of the resin layer 31.

The resin layer 31 and the second resin layer 33 contain different coloring components. The second resin layer 33 has a layer thickness gradually decreasing from a point P1 to a point P2. The second resin layer 33 can be formed by spray coating with a spray gun.

According to the embodiment of FIG. 7, a gradual change of color (gradation) can be expressed by an overlap between the resin layer 31 and the second resin layer 33 and by a layer thickness-decreasing portion of the second resin layer 33. This increases the variety of design.

FIG. 8 shows an embodiment which differs from the embodiments of FIGS. 1 to 7 in having an opening 35 in the resin layer 31. Hereinbelow, description will be made mainly about differences.

In the embodiment of FIG. 8, the resin layer 31 has an opening 35 leading to the surface 200 within an area where the resin layer is adhered to the surface 200 of the metallic plating layer 20 (in a broad sense, to the exterior surface 100 of the product 10), and the opening 35 is filled with a transparent protection layer 40. With this structure, the surface of the product is provided with an area permitting the metallic luster on the surface 200 to emerge through the transparent protection layer 40 and an area permitting the metallic luster on the surface 200 to emerge with a color of the resin layer 31. According to the embodiment of FIG. 8, therefore, delicate decorations such as hollow letters or hollow patterns can be made by properly setting the planar shape of the opening 35.

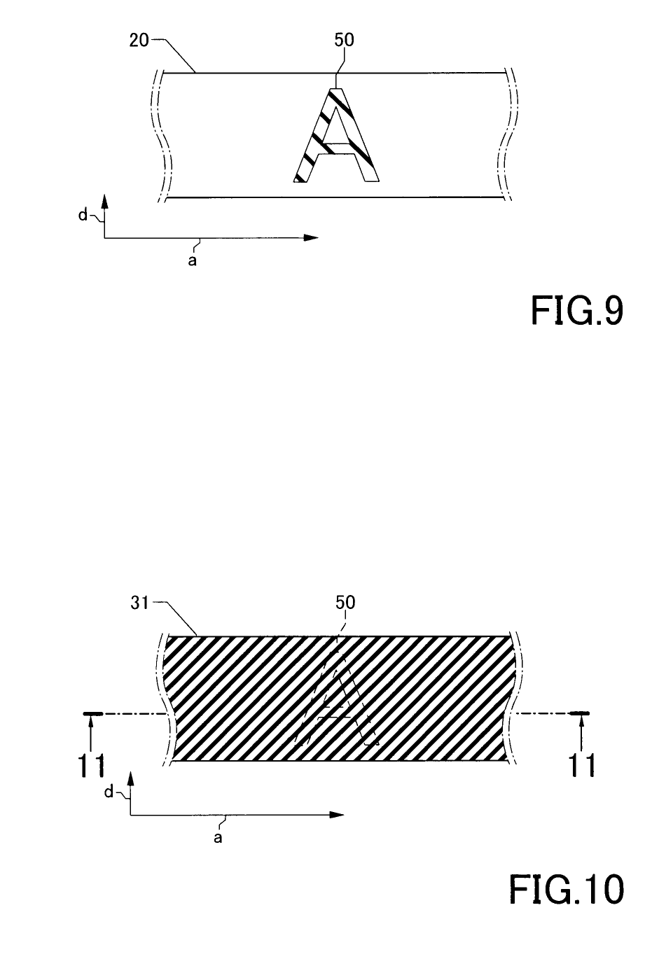

The effects of the product shown in FIG. 8 will be further described from the viewpoint of the manufacturing method with reference to FIGS. 9 to 13. At first, the metallic plating layer 20 is formed on the exterior surface 100 of the product body 10 by electroplating or chemical reduction plating. Prior to applying a coating thereto, the metallic plating layer 20 is subjected to the cleaning treatment described with reference with reference to FIGS. 3 to 5.

Referring next to FIG. 9, a peelable coating is applied to the surface 200 of the metallic plating layer 20 by screen printing to form a peelable area 50. For example, the peelable coating may be a two-pack type coating which is to be used by mixing a base with a hardener but does not include the hardener (hardening element) or a generally available coating mixed with a peeling accelerating component such as silicone oil.

In the screen printing process, although not clearly seen from FIG. 9, the peelable coating is put on a screen. The screen has a mask pattern corresponding to letters, symbols, logos or patterns (letters or the like), so that the peelable coating can be applied to the surface 200 of the metallic plating layer 20 lying beneath the screen by forcibly spreading the peelable coating on the screen with a squeegee, whereby the peelable area 50 such as letters or the like can be formed in accordance with the mask pattern. In FIG. 9, for example, the peelable area 50 is shown as the letter “A” of the alphabet.

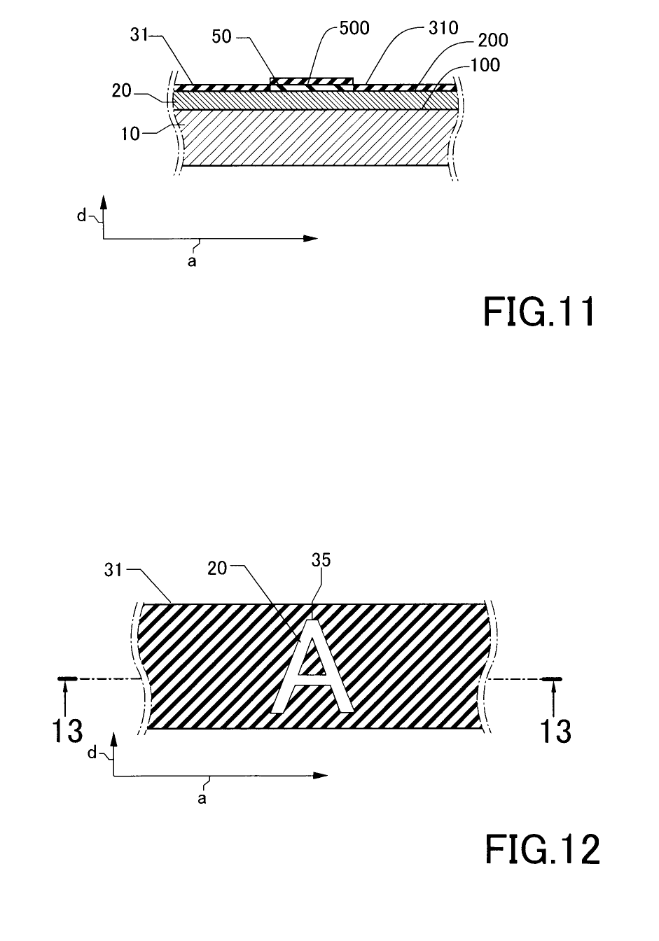

FIG. 10 shows a process after the process shown in FIG. 9, wherein a coating which becomes the resin layer 31 is applied to the surface 200 of the metallic plating layer 20 and a surface 500 of the peelable area 50 by spray coating with a spray gun or dip and squeeze coating. With this process, there can be obtained a work in process having the resin layer 31 formed on the surface 200 of the metallic plating layer 20 and the surface 500 of the peelable area 50, as shown in FIG. 11.

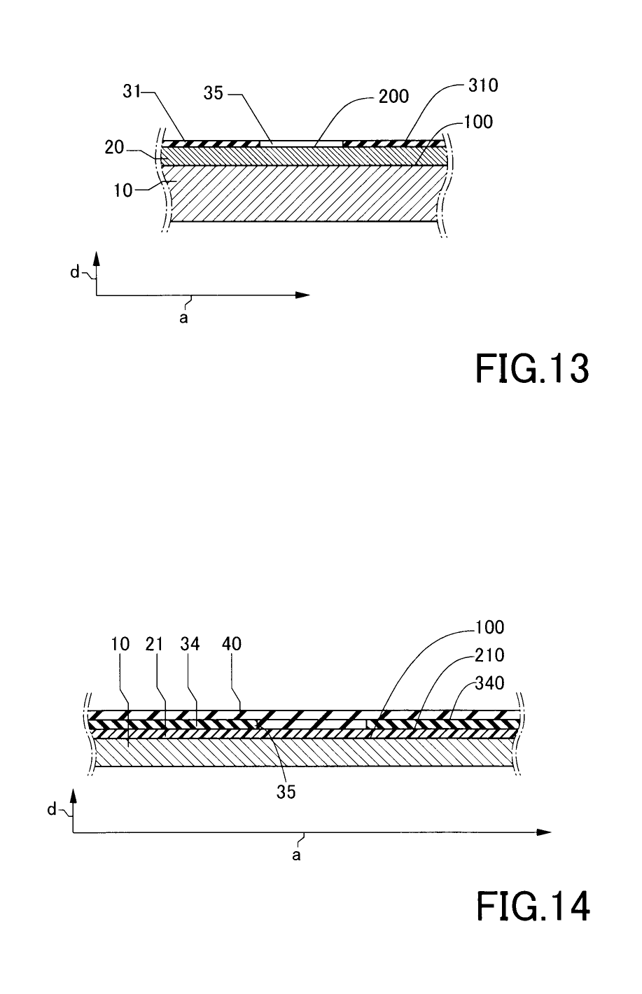

FIG. 12 shows a process after the process shown in FIGS. 10 and 11, wherein the surface of the work in process is then cleaned with a solvent or the like to remove the peelable area 50 together with the resin layer formed on the peelable area 50. With this process, the opening 35 leading to the surface 200 and exposing the surface 200 can be formed within an area where the resin layer 31 is adhered to the metallic plating layer 20, as shown in FIG. 13.

After the process shown in FIGS. 12 and 13, the product shown in FIG. 8 can be obtained by performing the heat treatment process and the formation process of the protection layer 40 described with reference to FIGS. 3 to 5.

According to the manufacturing method described with reference to FIGS. 9 to 13, the resin layer 31 can be formed on the surface 200 of the metallic plating layer 20 with various and delicate decorations such as hollow letters or hollow patterns that cannot be realized by masking or the like. Moreover, since a masking seal or a masking fee becomes unnecessary, its manufacturing cost can be reduced and its production yield can also be improved. Accordingly, various decorations can be made at a low cost.

Furthermore, since various and delicate decorations such as hollow letters or hollow patterns can be made by a screen printing technique, it is possible to deal with small-batch orders. According to a method in which masking or laser processing is used to remove a part of the resin layer 31, on the other hand, the manufacturing cost cannot be reduced. Particularly in the case of masking, it is impossible to deal with small-batch orders because a masking seal or a masking fee increases the cost.

FIG. 14 is a sectional view showing a product according to still another embodiment of the present invention with its ends omitted. The product is a golf club shaft, a fishing rod, a walking stick, a ski pole, a trekking pole, a tennis racket or a badminton racket. As the golf club shaft, for example, a steel shaft comprising a carbon steel (an alloy of Fe and C) and a fiber-reinforced plastic shaft comprising a fiber-reinforced plastic (FRP) are widely known. As the fiber-reinforced plastic shaft, moreover, a CFRP shaft using carbon fibers as reinforcements and a GFRP shaft using glass fibers as reinforcements are widely known. In the following description, a CFRP shaft (carbon shaft) is taken as an example for convenience of explanation, but it should not be construed as limitative.

The product of FIG. 14 comprises a product body 10, a base layer 21, a resin layer 34 and a protection layer 40. The product body 10 is a rod-like member. As used herein, the term “rod-like member” only means that a length taken along an axial direction “a” is larger than a maximum diameter taken along a radial direction “d”.

The product body 10 has a structure typical of carbon shafts. That is, the product body 10 is a tube-like or pipe-like member having a circular section and tapered along the axial direction “a” from one end (grip side) to the other end (head side) with a hollow portion passing through it along the axial direction “a”.

The base layer 21 is provided to cover the product body 10 and is adhered to its exterior surface 100 from the viewpoint of imparting impact resistance, abrasion resistance, corrosion resistance, weather resistance and decorativeness to the product body 10. The base layer 21 can be selected from ones capable of being adhered to the exterior surface 100 of the product body 10 and can mainly comprise a metallic material or a synthetic resin.

The resin layer 34 comprises a resin component and a coloring component and optionally an adhesive component and is adhered to a surface 210 of the base layer 21, preferably permitting the base layer 21 to be seen through its surface 340. The resin component of the resin layer 34 can be selected from ones capable of being adhered to the surface 210 of the base layer 21. The resin layer 34 has a layer thickness of, preferably, 0.3 mm or less, more preferably, 0.1 mm or less.

The adhesive component of the resin layer 34 should be contained in the case where the base layer 21 mainly comprises a metallic material, and preferably contains, as a main component, at least one kind of material selected from the group consisting of an isocyanate, a block isocyanate resin and a silane coupling agent. The silane coupling agent includes an epoxy group and a silane (Si) in its structure and is preferably selected from the following (i) to (v).
(i) 3-Aminopropyltriethoxysilane
(ii) 3-Aminopropyltrimethoxysilane
(iii) N-(2-Aminoethyl)-3-Aminopropyltrimethoxysilane
(iv) N-(2-Aminoethyl)-3-Aminopropylmethyldimethoxysilane
(v) 3-(N-Phenyl)-3-Aminopropyltrimethoxysilane

In the present invention, the term “adhesion” refers to the property of being inseparable during the service life of the product. In the present invention, the term “adhesive component” refers to a material which has an adhesive effect by itself and does not include an auxiliary adhesive material such as adhesion promoter.

The resin component of the resin layer 34 can be selected from conventionally used ones without particular limitation. In the case where the base layer 21 mainly comprises a metallic material, however, the resin component of the resin layer 34 should be able to be mixed with the adhesive component and comprises at least one kind of material selected from the group consisting of a melamine resin, an acrylic resin, an epoxy resin and an urethane resin.

The coloring component of the resin layer 34 mainly comprises a dye or a pigment and is mixed at a ratio of 15 wt. % or less. The coloring component can be selected from conventionally used ones without particular limitation. Examples include a titanium oxide, an organic red pigment, a barium sulfate and a carbon black. The content of the coloring component can be adjusted depending on a color tone to be obtained by the coloring component.

Once again, FIG. 14 will be referred to for explanation. The resin layer 34 mainly comprises a synthetic resin and has an opening 35 leading to the surface 210 within an area where the resin layer is adhered to the surface 210 of the base layer 21 (in a broad sense, to the exterior surface 100 of the product 10), permitting the base layer 21 to be seen through the opening 35.

On the surface 340 of the resin layer 34, moreover, the protection layer 40 is formed of a transparent synthetic resin material. The resin of the protection layer 40 can be selected from ones having recoatability with the resin layer 34 or ones capable of being adhered to the resin layer 34 and is preferably the same as or similar to the synthetic resin material of the resin layer 34. The protection layer 40 is provided to ensure impact resistance, abrasion resistance, corrosion resistance, weather resistance, etc. (durability) and may have a higher hardness than the resin layer 34.

The protection layer 40 is provided to ensure durability for the resin layer 34, the base layer 21 and the product body 10. In FIG. 14, the protection layer 40 is depicted as having a single-layer structure for convenience of explanation, but it should not be construed as limitative. The composition of the protection layer 40 can be adjusted depending on its purpose. When a transparent protection layer 40 is formed on the resin layer 34, particularly, this layer prevents peeling, discoloring and improper movement of the resin layer 34. Furthermore, various colors can be produced by adhering a protection layer 40 containing a coloring component having a different color tone from the resin layer 34.

In the embodiment of FIG. 14, the resin layer 34 has the opening 35 leading to the surface 210 within an area where the resin layer is adhered to the surface 210 of the base layer 21 (in a broad sense, to the exterior surface 100 of the product 10), and the opening 35 is filled with the transparent protection layer 40. With this structure, the surface of the product is provided with an area permitting the metallic luster or color on the surface 210 of the base layer 21 to emerge through the transparent protection layer 40 and an area permitting the metallic luster or color on the surface 210 of the base layer 21 to emerge with a color of the resin layer 34.

According to the embodiment of FIG. 14, delicate decorations such as hollow letters or hollow patterns can be made by properly shaping the opening 35.

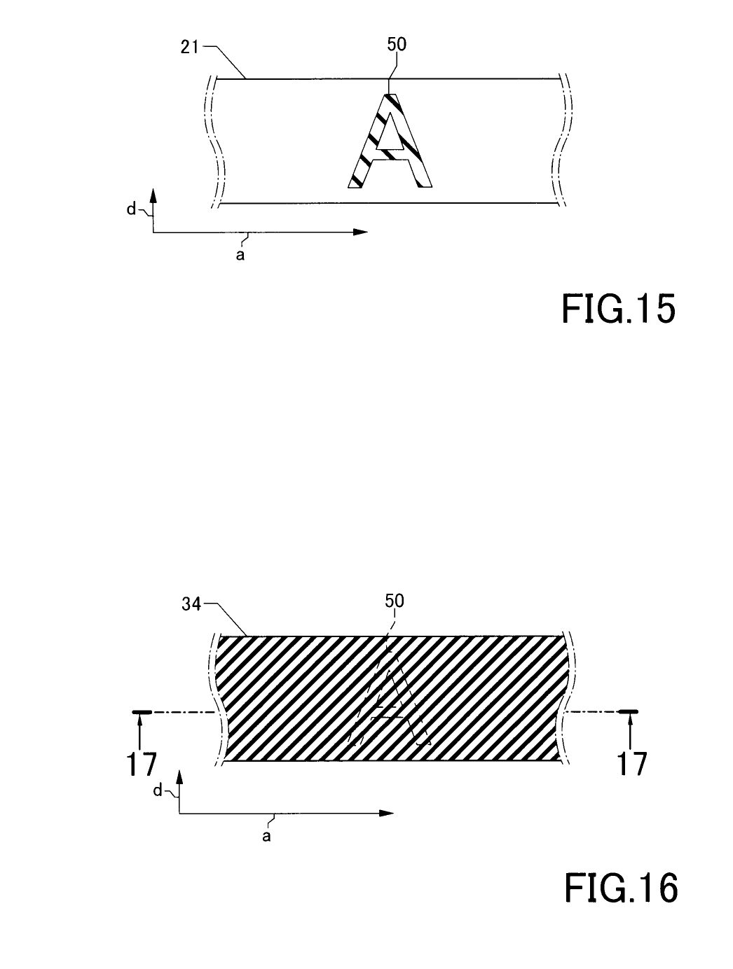

The effects of the product shown in FIG. 14 will be further described from the viewpoint of the manufacturing method with reference to FIGS. 15 to 19. At first, the base layer 21 is formed on the exterior surface 100 of the product body 10. Prior to applying a coating thereto, the base layer 21 is subjected to a cleaning treatment. Specifically, the cleaning treatment includes a washing process and a degreasing process, and in the washing process, dust or stain adhering to the surface (210) of the base layer 21 is removed by using a neutral detergent. In the degreasing process, then, the base layer 21 from the surface of which dust or the like is removed by the washing process is further processed such that greasy stain adhering to the base layer 21 is removed by a waste impregnated with naphtha.

Referring next to FIG. 15, a peelable coating is applied to the surface 210 of the base layer 21 by screen printing to form a peelable area 50. For example, the peelable coating may be a two-pack type coating which is to be used by mixing a base with a hardener but does not include the hardener (hardening element) or a generally available coating mixed with a peeling accelerating component such as silicone oil.

In the screen printing process, although not clearly seen from FIG. 15, the peelable coating is put on a screen. The screen has a mask pattern corresponding to letters, symbols, logos or patterns (letters or the like), so that the peelable coating can be applied to the surface 210 of the base layer 21 lying beneath the screen by forcibly spreading the peelable coating on the screen with a squeegee, whereby the peelable area 50 such as letters or the like can be formed in accordance with the mask pattern.

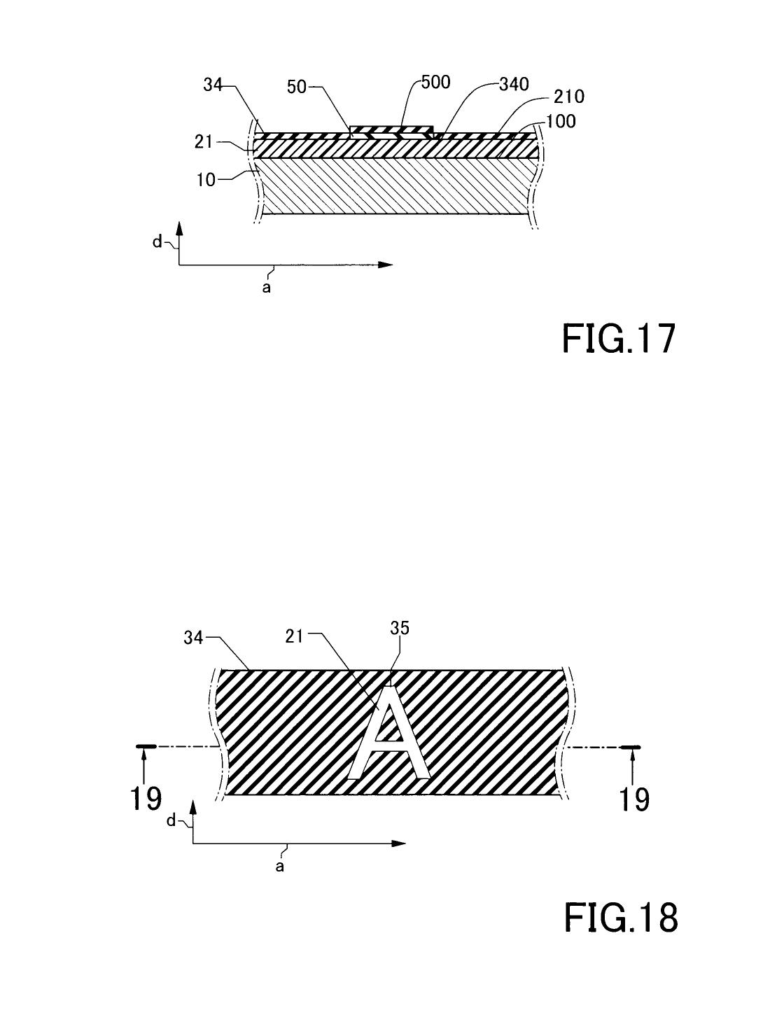

FIG. 16 shows a process after the process shown in FIG. 15, wherein a coating which becomes the resin layer 34 is applied to the surface 210 of the base layer 21 and a surface 500 of the peelable area 50 by spray coating with a spray gun or dip and squeeze coating. With this process, there can be obtained a work in process having the resin layer 34 formed on the surface 210 of the base layer 21 and the surface 500 of the peelable area 50, as shown in FIG. 17.

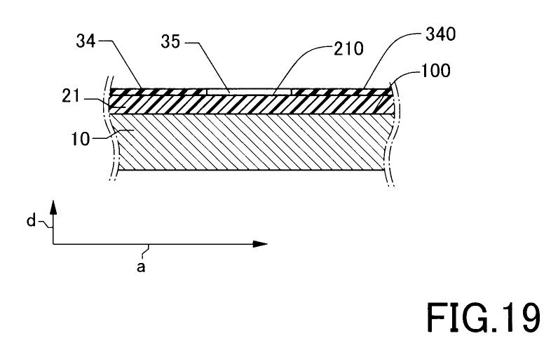

FIG. 18 shows a process after the process shown in FIGS. 16 and 17, wherein the surface of the work in process is then cleaned with a solvent or the like to remove the peelable area 50 together with the resin layer 34 formed on the peelable area 50. With this process, the opening 35 leading to the surface 210 and exposing the surface 210 can be formed within an area where the resin layer 34 is adhered to the surface 210 of the base layer 21, as shown in FIG. 19.

After the process shown in FIGS. 18 and 19, the product shown in FIG. 14 can be obtained by performing the drying process (heat treatment process) of the resin layer 34 and the formation process of the protection layer 40.

According to the manufacturing method described with reference to FIGS. 15 to 19, the resin layer 34 can be formed on the surface 210 of the base layer 21 with various and delicate decorations such as hollow letters or hollow patterns that cannot be realized by masking or the like. Moreover, since a masking seal or a masking fee becomes unnecessary, its manufacturing cost can be reduced and its production yield can also be improved. Accordingly, various decorations can be made at a low cost.

Furthermore, since various and delicate decorations such as hollow letters or hollow patterns can be made by a screen printing technique, it is possible to deal with small-batch orders.

According to a method in which masking or laser processing is used to remove a part of the resin layer 34, on the other hand, the manufacturing cost cannot be reduced. Particularly in the case of masking, it is impossible to deal with small-batch orders because a masking seal or a masking fee increases the cost.

While the present invention has been particularly shown and described with respect to preferred embodiments thereof, it will be understood by those skilled in the art that various changes in form and detail may be made therein without departing from the spirit, scope and teaching of the invention.

What is claimed is:

1. A product comprising a product body, a metallic plating layer and a resin layer,
the product body being a rod-like member mainly comprising a metallic material,
the metallic plating layer having a metallic luster on its surface and covering an exterior surface of the product body,
the resin layer comprising a thermosetting resin and an adhesive component and being adhered to the surface of the metallic plating layer, permitting the metallic plating layer to be seen through the resin layer.

2. The product of claim 1, wherein the resin layer further comprises a coloring component.

3. A product comprising a product body, a metallic plating layer, a first resin layer and a second resin layer,
the product body being a rod-like member mainly comprising a metallic material,
the metallic plating layer having a metallic luster on its surface and covering an exterior surface of the product body,
the first resin layer comprising a thermosetting resin and an adhesive component and being adhered to the surface of the metallic plating layer,
the second resin layer comprising a thermosetting resin and a coloring component and being adhered to a surface of the first resin layer, permitting the metallic plating layer to be seen through the first resin layer and the second resin layer.

4. The product of claim 1, which is a golf club shaft, a fishing rod, a walking stick, a ski pole, a trekking pole, a tennis racket or a badminton racket.

5. The product of claim 2, which is a golf club shaft, a fishing rod, a walking stick, a ski pole, a trekking pole, a tennis racket or a badminton racket.

6. The product of claim 3, which is a golf club shaft, a fishing rod, a walking stick, a ski pole, a trekking pole, a tennis racket or a badminton racket.

7. A method for manufacturing the product of claim 1, comprising the steps of:
forming the metallic plating layer on the surface of the product body by electroplating or chemical reduction plating;
applying a coating comprising a thermosetting resin and an adhesive component to the surface of the metallic plating layer; and
hardening the coating by subjecting the product body to a heat treatment.

8. A method for manufacturing the product of claim 2, comprising the steps of:
forming the metallic plating layer on the surface of the product body by electroplating or chemical reduction plating;
applying a coating comprising a thermosetting resin and an adhesive component to the surface of the metallic plating layer; and
hardening the coating by subjecting the product body to a heat treatment.

9. A method for manufacturing the product of claim 3, comprising the steps of:
forming the metallic plating layer on the surface of the product body by electroplating or chemical reduction plating;
applying a coating comprising a thermosetting resin and an adhesive component to the surface of the metallic plating layer; and
hardening the coating by subjecting the product body to a heat treatment.

10. A method for manufacturing the product of claim 4, comprising the steps of:
forming the metallic plating layer on the surface of the product body by electroplating or chemical reduction plating;
applying a coating comprising a thermosetting resin and an adhesive component to the surface of the metallic plating layer; and
hardening the coating by subjecting the product body to a heat treatment.

11. A method for manufacturing the product of claim 5, comprising the steps of:
forming the metallic plating layer on the surface of the product body by electroplating or chemical reduction plating;
applying a coating comprising a thermosetting resin and an adhesive component to the surface of the metallic plating layer; and
hardening the coating by subjecting the product body to a heat treatment.

12. A method for manufacturing the product of claim 6, comprising the steps of:
forming the metallic plating layer on the surface of the product body by electroplating or chemical reduction plating;
applying a coating comprising a thermosetting resin and an adhesive component to the surface of the metallic plating layer; and
hardening the coating by subjecting the product body to a heat treatment.

13. A product comprising a product body and a resin layer,
the product body being a rod-like member mainly comprising a metallic material or a fiber-reinforced plastic,
the resin layer comprising a resin component and a coloring component and having an opening leading to a surface of the product body within an area where the resin layer is adhered to the surface of the product body.

14. The product of claim 13, which is a golf club shaft, a fishing rod, a walking stick, a ski pole, a trekking pole, a tennis racket or a badminton racket.

15. A method for manufacturing the product of claim 13, comprising the steps of:
printing a peelable coating on the surface of the product body by screen printing to form a peelable area on the surface of the product body in accordance with a mask pattern;
applying a resin coating comprising a resin component and a coloring component to the surface of the product body and a surface of the peelable area; and
removing the peelable area and the resin coating applied onto the peelable area.

16. A method for manufacturing the product of claim 14, comprising the steps of:
printing a peelable coating on the surface of the product body by screen printing to form a peelable area on the surface of the product body in accordance with a mask pattern;
applying a resin coating comprising a resin component and a coloring component to the surface of the product body and a surface of the peelable area; and
removing the peelable area and the resin coating applied onto the peelable area.
